(19) United States
(12) Patent Application Publication
(10) Pub. No.: US 2008/0202564 A1
(43) Pub. Date: Aug. 28, 2008

(54) PROCESSING SYSTEM WITH IN-SITU CHEMICAL SOLUTION GENERATION

(76) Inventor: Dana Scranton, Kalispell, MT (US)

Correspondence Address: PERKINS COIE LLP/SEMITOOL, PO BOX 1208, SEATTLE, WA, 98111-1208, US

(21) Appl. No.: 11/679,479

(22) Filed: Feb. 27, 2007

(51) Int. Cl. B08B 3/00

(52) U.S. Cl. 134/95.2; 134/30; 134/94.1; 204/298.01

(57) ABSTRACT

A system for processing a workpiece includes a dry process chamber, such as a plasma etching chamber, and a wet process chamber, such as a spin/spray chamber. Gas supply lines supply gases to the dry process chamber, and to a chemical solution generator. A liquid supply line supplies a liquid, such as de-ionized water, to the chemical solution generator. The chemical solution generator manufactures liquid chemical solutions in situ, for point of use in the wet process chamber. The system allows for both wet and dry processing with few or no separate liquid chemical supply lines.

### BACKGROUND

Etching or stripping processes are often used in manufacturing semiconductor and similar devices, to remove material from a wafer or substrate. Photo resist which is used in forming interconnect patterns and other features on the wafer, must typically be removed by etching, before further manufacturing steps may be performed on the wafer. Other layers and materials may also be removed by etching types of processes, at various stages during manufacture of semiconductor and similar devices. To avoid defects in the devices, the photoresist or other material generally must be removed completely, without leaving any residue.

Plasma etching or ashing may be used to remove the bulk of a material such as photoresist. Any residual material may then be removed using wet cleaning processes. Plasma etching typically involves applying a plasma gas onto the surface of the wafer to selectively oxidize the photoresist or other material. Wet cleaning processes involve applying liquid chemical solutions onto the wafer to remove any residual material not removed by the plasma process and/or to perform other steps. Wet cleaning is often carried out in a single-wafer spin/spray cleaning chamber.

Plasma etching uses various gases. The gases used generally vary depending on the material to be etched. In conventional plasma etching equipment, these gases are supplied to the plasma processing chamber from gas bottles or from factory bulk gas sources. Microwave or RF energy ionizes the gas forming plasma in the plasma process chamber. Alternatively, the plasma may be formed in an upstream chamber and then moved into the plasma process chamber.

Wet cleaning processes use one or more liquids, typically including high purity deionized water, containing one of more chemicals. The chemicals are generally mixed into the water in a remote vessel, with the mixture of chemicals and water then pumped to the wet process chamber in a liquid supply line.

Systems or tools that combine both plasma process chambers and wet process chambers have been proposed, to reduce space and wafer handling requirements, as well as overall processing time requirements. While these types of combined or integrated plasma etching/wet-chemical cleaning systems may have met with varying degrees of success, engineering challenges remain in creating improved systems.

### SUMMARY

A new system for etching, stripping or cleaning workpieces provides for highly versatile processing in a more compact space, with fewer components, and with less complexity. As a result, workpiece processing is improved, and manufacturing costs may be reduced. In this new system, gas supply sources are used to supply process gases into a dry process chamber. These gas supply sources are also used to generate one or more liquid chemical solutions. This avoids the need for additional separate supplies of liquid chemical solutions, and the pumps, tanks and other similar components associated with liquid chemical solution supply systems. Potential for contamination may also be reduced by generating the liquid chemical solutions using process gases.

The invention resides in sub-combinations of the methods and systems described. Features described or shown in connection with one embodiment may be used, alone or in combination, in other embodiments as well.

### BRIEF DESCRIPTION OF THE DRAWINGS

In the drawings, where the same reference number indicates the same element in each of the views:

FIG. 1 is a perspective of a workpiece processing system.

FIG. 2 is a plan view of the system shown in FIG. 1.

FIG. 3 is a plan view of an alternative design.

FIG. 4 is a plan view of another alternative design.

FIG. 5 is a schematic view of a liquid chemical solution generator that may be used in the systems shown in FIGS. 1-4.

### DETAILED DESCRIPTION OF THE DRAWINGS

The term workpiece or wafer means any flat media or article, including a semiconductor wafer or other substrate, glass, mask, optical, disk, thin film or memory media, flat panel displays, MEMs substrates, and any other substrates upon which microelectronic circuits or components, data storage elements, and/or micro-mechanical, micro-electromechanical or micro-optical elements are or can be formed.

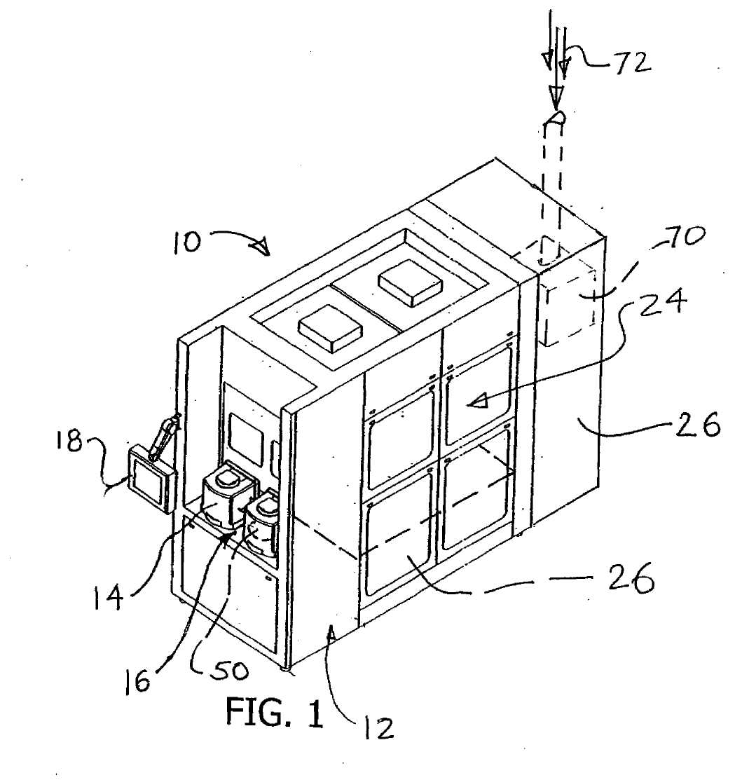

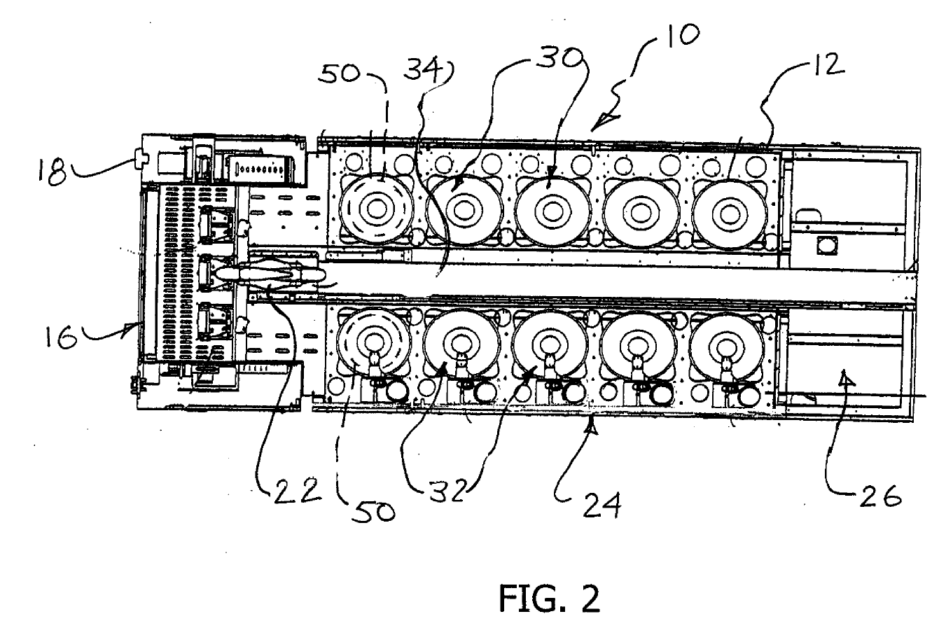

Turning now to the drawings, as shown in FIGS. 1 and 2, a processing system 10 has a housing or enclosure 12. Wafers 50 within containers such as front opening unified pods (FOUP) 14 may be moved into and out of the enclosure 12 for processing, at a load/unload or docking station 16. The processing system 10 may be controlled and monitored through an electronic controller 18.

Referring to FIG. 2, for purpose of description, the space within the enclosure 12 may be considered as including a processor section 24, and a chemical supply section 26. In the design shown, dry process chambers 30 are arranged in one row and wet process chambers 32 are arranged in a second parallel row on an opposite side of a robot pathway 34 within the processor section 24. The dry process chambers 30 may be plasma etch or ash processors. The wet process chambers 32 may be spin/spray processors. A robot 22 is moveable along the robot path 34, to move wafers from the load/unload station 16 to the chambers 30 and 32, and/or between the chambers 30 and 32 (or other chambers as well).

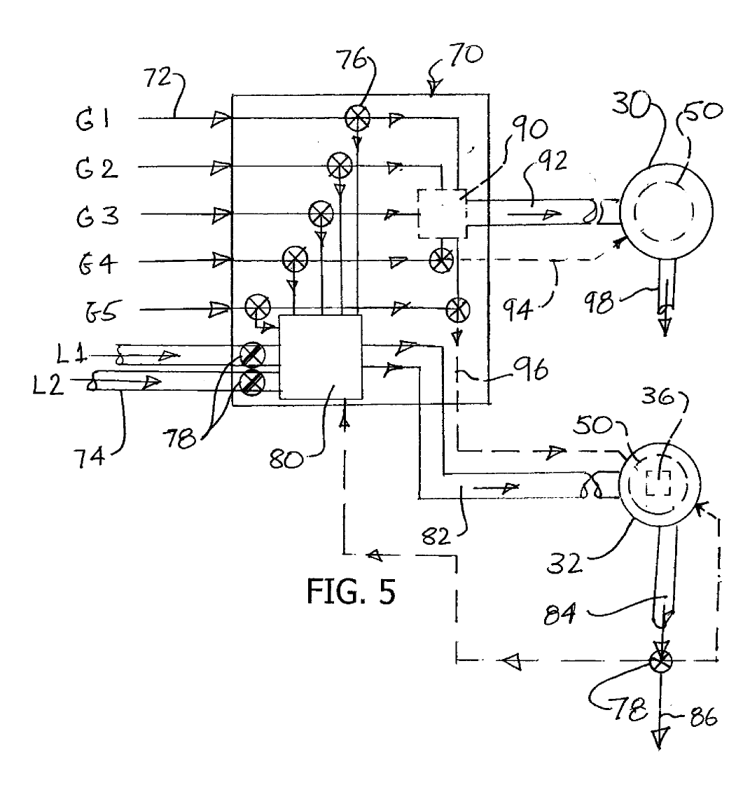

Turning now to FIG. 5, the dry process chamber 30 performs a dry etching or ashing process on the wafer 50. This process uses gases. Typically, two or more gases are used. The processing system 10 has gas sources, such as gas bottles within the enclosure 12 or more typically, gas supply lines providing gases to the processing system 10 from remote bulk gas storage locations in the manufacturing facility. FIG. 5 shows a design where five different gases may be used by the dry process chambers 30.

Referring to FIGS. 1 and 5, gas supply lines 72 extend into a chemical solution generator 70 in the chemical supply section 26 within the enclosure 12. In FIG. 5, the five gas supply lines 72 shown are indicated as G1, G2, G3, G4, and G5. Using plumbing connections and valves 76, each of the gases G1-G5 may be provided directly into the dry process chamber 30 via bypass lines 94. Alternatively, the gases may be combined or mixed together in a gas mixer 90, and then provided into the dry process chamber 30 via a chamber gas supply line 92.

The wet process chamber 32 performs wet processing on the wafer 50, using one or more liquids. The liquid typically includes deionized water, and one or more chemicals. Referring still to FIG. 5, a liquid supply line 74 carries a liquid, typically deionized water, from a remote location in the manufacturing facility, into a gas/liquid mixer 80 in the chemical solution generator 70. By controlling the gas valves 76, one or more of the gases G1-G5 are supplied from the gas lines 72 into the gas/liquid mixer 80. The gas/liquid mixer 80 combines the liquid and the gas(es) to form a liquid chemical solution delivered into the wet processing chamber 32 through a chemical solution supply line 82.

As shown in FIG. 5, a second liquid supply line 74 may also be used, depending on the liquid chemical solutions to be used in the wet processing chamber 32. Liquid valves 78 may be used in the liquid supply line(s) to control flow of liquid into the gas liquid mixer 80. As also shown in FIG. 5, any one of the gases G1-G5 may optionally be supplied as a dry gas directly into the wet processing chamber 32 via a wet processing chamber gas inlet line 96.

The liquid chemical solution used in the wet processing chamber 32 may be formed in the mixer 80 by dissolving one or more of the gases G1-G5 into the liquid. The gas may optionally also be partially or fully entrained in the liquid, rather than dissolved. In some applications, the gas(es) may also be chemically react with the liquid, forming a new chemical compound as the solution provided to the wet processing chamber 32.

Referring to FIGS. 1 and 5, in use, a container 14 holding wafers 50 is placed at the load/unload station 16 of the processing system 10. The wafer 50 is then removed from the container 14 by the robot 22 and placed into a dry process chamber 30. Dry process gases (G1 up to G5) are provided via the gas lines 72 into the dry process chamber 30. The gases G1-G5 may include HF, HCL , ozone, oxygen, ammonia, or tetrafluoromethane. The gases may optionally be combined in the gas mixer 90 before moving into the dry process chamber 30. The dry process chamber 30 performs a dry process on the wafer 50, such as plasma etching. Used processing gases, vapors, or process by-products are removed from the chamber 30 via an exhaust line 98. Each of the dry process chambers may perform a gas phase process, such as plasma etching.

After completion of dry processing, the robot 22 removes the wafer 50 from the dry process chamber 30 and moves the wafer 50 into a wet process chamber 32. The liquid chemical solution needed for processing in the wet process chamber 32 is generated by combining one or more of the process gases G1-G5 with one or more liquids in the gas/liquid mixer 80. The liquid chemical solution created via the combination of gas and liquid is provided into the wet process chamber 32 for processing the wafer 50. Used liquid and gases or vapors may be removed from the wet process chamber 32 via an exhaust/drain line 84. The liquid removed from the wet processing chamber 32 may optionally be directed to a recirculation line for recirculation back to the wet processing chamber 32 directly, or optionally, through the gas/liquid mixer 80. Alternatively, the liquid may be directed out to a facility drain 86. The wet process chamber 32 may include a sonic transducer, a heater, or an optical energy source 36, such as a UV or IR light. Each of the wet process chambers may perform a liquid phase process, such as etching, stripping, cleaning, rinsing, etc.

The wet process chamber 32 may also be equipped to rinse and dry the wafer 50. After completion of wet processing, the robot 22 removes the processed wafer 50 from the wet process chamber 32 and moves the wafer back into a container 14 at the load/unload station 16, or to another location.

The chemical solution generator 70 allows in-situ generation of liquid process chemical solutions for use in the wet process chambers. Since the liquid chemical solutions are generated using gases already available in the system 10, the cost and complexity of having additional chemical solution supply lines is avoided. Fewer pumps, tanks, and similar components are needed. As a result, the processing in system 10 may be compact yet still highly versatile in performing various processing operations.

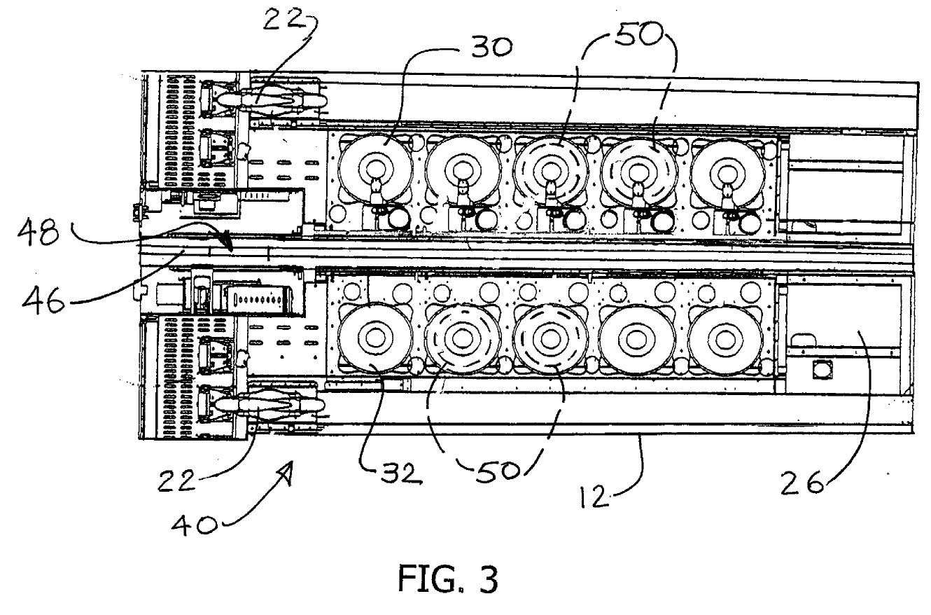

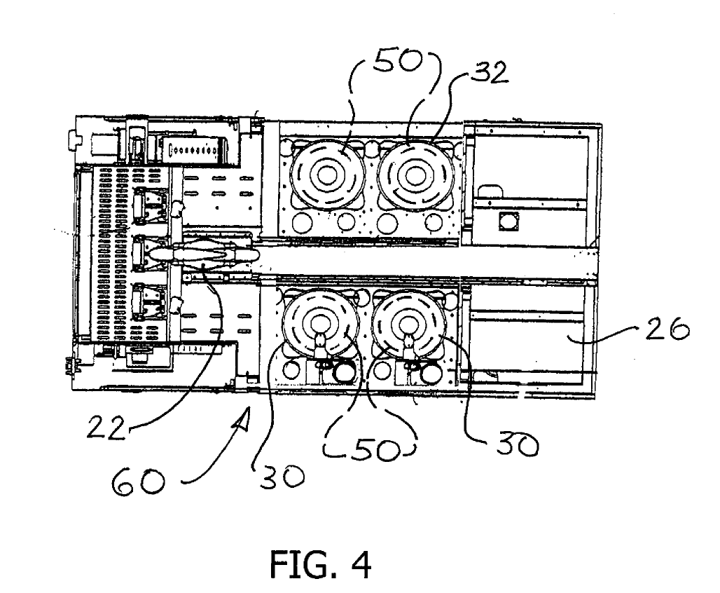

FIGS. 3 and 4 show alternative processing systems. The processing system 40 shown in FIG. 3 is similar to the processing system 10 shown in FIGS. 1 and 2 and includes a dividing wall 46 separating the dry process chambers 30 from the wet process chambers 32. The dividing wall 46 prevents movement of any particles, vapors, or gases from the dry process chambers 30 to the wet process chambers 32, and vice versa. A pass through window 48 may be provided in the dividing wall 46, adjacent to the load/unload station 16, to allow transfer of wafers from one side to the other side of the dividing wall 46. Separate robots 22 are also shown in FIG. 3 for loading and unloading the dry process chambers 30 and the wet process chambers 32. However, a generally centrally located single robot adjacent to one side of the dividing wall 46 may alternatively be used, with one or more pass through windows 48 positioned to allow desired wafer movement.

FIG. 4 shows another processing system 60 similar to the processing system 10 shown in FIGS. 1 and 2, and having two dry process chambers 30 and two wet process chambers 32. Of course, the processing systems may have any number of dry or wet process chambers.

Referring to FIGS. 24, the chemical supply section 26 which includes the chemical solution generator 70 is shown at the back end of the enclosure 12. However, the chemical supply section 26 and chemical solution generator 70 may be located at various positions on, within, or adjacent to, the enclosure 12. For example, as shown in dotted lines in FIG. 1, the chemical supply section 26 including the chemical solution generator 70 may be positioned underneath one or more of the process chambers 30 or 32.

Thus, novel processing systems and methods have been shown and described. Various changes, modifications, and substitutions of equivalents may of course be made, without departing from the spirit and scope of the invention. The invention, therefore, should not be limited, except to the following claims and their equivalents.

1. A system comprising:
a first process chamber;
a second process chamber adjacent to the first process chamber;
a chemical solution generator adjacent and connecting to the second process chamber;
a process gas supply connecting to the first process chamber and to the chemical solution generator; and
a liquid supply connecting to the chemical solution generator.

2. The system of claim 1 further comprising an enclosure, and with the first and second process chambers and the chemical solution generator substantially within the enclosure.

3. The system of claim 1 with the first process chamber comprising a plasma etch chamber and the second process chamber comprising a spin/spray process chamber.

4. The system of claim 1 with the second process chamber comprising a spin/spray process chamber including a sonic transducer.

5. The system of claim 1 with the second process chamber comprising a spin/spray process chamber including an optical energy source.

6. The system of claim 1 with the first process chamber comprising an etch chamber and the second process chamber comprising a spin/spray process chamber, and with the process gas supply also connecting into the second process chamber.

7. The system of claim 1 with the chemical solution generator comprising a gas/liquid mixer for mixing at least one gas from the process gas supply with a liquid from the liquid supply to make a liquid chemical solution.

8. The system of claim 1 with the process gas supply comprising a source for one or more of HF vapor, HCl vapor, ozone, oxygen, ammonia and tetrafluoromethane.

9. The system of claim 1 further comprising a heater for heating the first process chamber or the second process chamber.

10. The system of claim 1 further comprising a liquid recirculation line connecting the second process chamber to the chemical solution generator.

11. A system for process a workpiece, comprising:
a plasma etching chamber;
two or more process gas supply lines connecting to the plasma etching chamber;
a liquid process chamber;
a rotor in the liquid process chamber for holding and rotating the workpiece;
a chemical solution generator connecting to the liquid process chamber and to at least one of the process gas supply lines; and
a liquid supply connecting to the chemical solution generator.

12. A system comprising:
an enclosure;
a first process chamber and a second process chamber in the enclosure;
a gas supply connecting to the first and second process chambers;
a liquid supply connecting to the second process chamber; and
means for mixing a gas and a liquid in the second process chamber to form a process chemical solution in the second process chamber.

13. A system for processing a workpiece, comprising:
a plasma etching chamber within a first enclosure;
two or more process gas supply lines connecting to the plasma etching chamber;
a liquid process chamber in a second enclosure adjacent to the first enclosure;
a rotor in the liquid process chamber for holding and rotating the workpiece;
a chemical solution generator connecting to the liquid process chamber and to at least one of the process gas supply lines; and
a liquid supply connecting to the liquid chemical solution generator.

14. The system of claim 13 with the second enclosure and the first enclosure sharing a common wall.

15. The system of claim 13 with the second enclosure contacting the first enclosure.

16. A method comprising:
supplying a first process gas into a dry process chamber;
dry processing a workpiece in the dry process chamber using the first chemical process gas;
supplying a second process gas into a dry process chamber;
dry process the workpiece in the dry process chamber using the second process gas;
moving the workpiece into a wet process chamber;
mixing a liquid with at least one of the first and second process gases at a location adjacent to the wet process chamber, to make a liquid process chemical solution; and
applying the process chemical solution onto the workpiece in the wet process chamber.

17. The method of claim 16 wherein the dry processing comprises plasma etching.

18. The method of claim 16 further comprising mixing the process gas with the liquid in a chemical solution generator, and with the dry process chamber, the wet process chamber, and the chemical solution generator within an enclosure.

19. The method of claim 16 further comprising isolating the dry process chamber from the wet process chamber via a dividing wall between them.

20. The method of claim 16 further comprising exposing the workpiece in the wet process chamber to sonic or optical energy.
